(19) United States
(12) Patent Application Publication
(10) Pub. No.: US 2008/0101260 A1
(43) Pub. Date: May 1, 2008

(54) Parent terminal selection method and terminal having parent terminal selection function for use in star-type connection AD HOC wireless network

(75) Inventor: Tatsuhiko Maruyama, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (KP)

(21) Appl. No.: 11/978,599

(22) Filed: Oct. 30, 2007

(30) Foreign Application Priority Data
Oct. 31, 2006 (JP) 2006-296200

(51) Int. Cl. H04L 12/28

(52) U.S. Cl. 370/255

(57) ABSTRACT

A parent terminal collects remaining battery capacities of terminals (steps S201-S202, step S212) and monitors data transmission/reception amounts (step S203). The parent terminal calculates remaining battery times of the terminals, which are estimated assuming that each terminal becomes a parent terminal, from a change in the remaining battery capacities and the data transmission/reception amounts (step S208). Based on the calculation result, the parent terminal selects a terminal that maximizes the total of the remaining battery times of all terminals (average of remaining battery times of the terminals) as a parent terminal (step S209).

### REFERENCE TO RELATED APPLICATION

This application is based upon and claims the benefit of the priority of Japanese patent application No. 2006-296200, filed on Oct. 31, 2006, the disclosure of which is incorporated herein in its entirety by reference thereto.

### FIELD OF THE INVENTION

The present invention relates to a parent terminal selection method and a terminal having a parent terminal selection function for use in a star-type connection ad hoc wireless network, and more particularly to a parent terminal selection method and a terminal having a parent terminal selection function for use in a star-type connection ad hoc wireless network where any participating terminal can become a parent terminal.

### BACKGROUND OF THE INVENTION

As portable wireless communication devices become widely used today, an ad hoc wireless network, which is configured in a self-configuring and decentralized manner only by network participating terminals, attracts more attention. For widespread use of ad hoc networks, an efficient network configuration method must be implemented. Especially, because the battery life of a wireless communication terminal is limited, there is a need for a network configuration (parent terminal selection) that minimizes the power consumption.

Instead of the conventional parent terminal selection method in which a terminal having the largest remaining battery capacity is selected as the parent terminal, Patent Document 1 proposes a parent terminal selection method in which the remaining battery times of the participating terminals are calculated and a terminal having the longest remaining battery time is selected as the parent terminal. A terminal X1 (X2 or X3) having the configuration shown in FIG. 11 collects remaining battery capacity information regularly using a remaining battery capacity monitor unit X102 (step S301) and stores the collected information in a remaining battery capacity information storage unit X103 (step S302), as shown in FIG. 12A. To select the parent terminal, each terminal X1 (X2 or X3) estimates the battery shut-off time using a battery shut-off time estimation unit X106 (step S303) and sends the estimated time to the parent terminal (step S304) as shown in FIG. 12B. If there is no terminal that will be able to operate longer than the parent terminal, the parent terminal does not issue a parent terminal change instruction. Conversely, if there is a terminal that will be able to operate longer than the parent terminal, the parent terminal issues an instruction to a parent/child terminal change control unit X108 of all terminals to indicate that the parent terminal should be changed to that terminal (step S306).

Patent Document 2 proposes a method for maintaining a long-life network in which the parent terminal is selected considering the remaining battery capacity described above, as well as the terminal topology, to distribute the load among the terminals.

[Patent Document 1]

Japanese Patent Kokai Publication No. JP-P2003-32263A

[Patent Document 2]

Japanese Patent Kokai Publication No. JP-P2003-273883A

### SUMMARY OF THE DISCLOSURE

The following analyses on the related art are given by the present invention. The entire disclosure of Patent Documents 1 and 2 is incorporated herein by reference thereto.

A first problem with the conventional technology described above is that, when the parent terminal is selected, no consideration is paid for the load of the parent terminal that functions as a hub in a star-type connection ad hoc wireless network.

For example, when the remaining battery time is calculated by the method disclosed in Patent Document 1, no consideration is paid for the power consumption and the remaining battery capacity of a terminal that functions as the parent terminal after switching. This sometimes results in a frequent change of the parent terminal and, as a result, an increase in wasteful communication as described below.

For example, assume that terminal A is the parent terminal as shown in FIG. 13A. The parent terminal, which works also as a hub, has more communication amount than a child terminal. As a result, the remaining battery time of terminal A is estimated shorter than that of other terminals and so the parent terminal tends to be switched to another terminal.

When the parent terminal is switched to terminal B as shown in FIG. 13B, terminal B works as a hub and its communication amount is increased. As a result, the remaining battery time of terminal B estimated after a predetermined time becomes short and, so, the parent terminal tends to be switched to terminal A. The switching operation, if preformed frequently as described above, increases the power consumption, decreases the throughput, and makes wireless communication inefficient.

Another problem with the method described in Patent Document 1 is that the remaining battery capacity of a terminal not in communication tends to be estimated longer and selected as the parent terminal. This tendency results in more power consumption and degraded data throughput.

The following describes again the problems described above with reference to FIGS. 13A, 13B, and 13C. Suppose that terminals A, B, C, and D have the same communication characteristics and the same battery characteristics. FIG. 13A shows that terminal A is the parent terminal and that data communication is performed only between terminal C and terminal D. At this time, terminal B is not performing communication. This means that terminal B consumes less power and its remaining battery time is estimated longer than that of other terminals that are performing communication. So, at the next selection time, terminal B is selected as the parent terminal.

FIG. 13B shows that terminal B becomes the parent terminal and data communication is performed only between terminal C and terminal D. Similarly, because terminal A is not performing communication, its remaining battery time becomes long and terminal A becomes the parent terminal. After that, the parent terminal is switched between terminal A and terminal B alternately.

On the other hand, when terminal C becomes the parent terminal as shown in FIG. 13C, terminal A and terminal B consume less power. That is, when a terminal having the longest remaining battery time is selected as the parent terminal, terminal A and terminal B, which are not performing communication to transfer their own data, consume more power. As a result, the total power consumption of the network as a whole increases.

The parent terminal selection method described in Patent Document 2 is similar to the method described above in that a terminal having the largest remaining battery capacity or a terminal having the largest number of terminals in the communication range is selected. So, the potential problems are that a terminal not performing communication tends to be selected and that the parent terminal tends to consume more power with the result that the parent terminal is switched frequently. Accordingly, there is much to be desired in the art.

According to a first aspect of the present invention, there is provided a parent terminal selection method for use in a star-type connection ad hoc wireless network in which a plurality of terminals, each of which can become a parent terminal, participate. A terminal participating in the wireless network calculates remaining battery times of the terminals which are estimated assuming that each terminal becomes a parent terminal. Based on the calculated result, it selects a most appropriate parent terminal.

According to a second aspect of the present invention, there is provided a terminal that can participate in a star-type connection ad hoc wireless network as a parent terminal or a child terminal. The terminal comprises a remaining battery time calculation unit that calculates remaining battery times of terminals which are estimated assuming that each of the terminals becomes a parent terminal. The terminal further comprises a most-appropriate parent terminal selection unit that selects a most-appropriate parent terminal based on the remaining battery times of the terminals which are estimated assuming that the each terminal becomes a parent terminal.

The meritorious effects of the present invention are summarized as follows.

The method according to the present invention suppresses wasteful parent terminal switching and hunting phenomena and prolongs the network lifetime. The reason is that simulation is performed for the remaining battery times of all terminals participating in the network assuming that each terminal becomes the parent terminal and, based on the result, the parent terminal is selected. For example, instead of alternating between the status shown in FIG. 13A and the status shown in FIG. 13B, the method according to the present invention allows the network to directly enter the status shown in FIG. 13C, thus making it possible to configure a wireless network that is superior in data throughput and power saving.

### BRIEF DESCRIPTION OF THE DRAWINGS

FIG. 1 is a diagram showing the configuration of a terminal in a first example of the present invention connected to a star-type connection ad hoc wireless network.

FIG. 2 is a schematic diagram showing a star-type connection ad hoc wireless network for describing the first example of the present invention.

FIG. 3 is a flowchart showing the operation of a terminal in the first example of the present invention.

FIG. 4 is a diagram showing the image of the remaining battery capacities managed by a parent terminal in the first example of the present invention.

FIG. 5 is a diagram showing the image of the data transmission/reception amounts managed by the parent terminal in the first example of the present invention.

FIG. 6 is a diagram showing an example in which battery consumption amounts for a predetermined time (for example, Δt seconds) and battery consumption amounts for one-byte transmission/reception are calculated from the data in FIG. 4 and FIG. 5.

FIG. 7 is a diagram showing an example in which the remaining battery times of the terminals and their total values are calculated from the data in FIGS. 4-6 assuming that each terminal is the parent terminal.

FIGS. 8A and 8B are schematic diagrams showing another star-connection ad hoc wireless network for describing the effect of the first example of the present invention.

FIG. 9 is a diagram showing a table containing the remaining battery times of the terminals and the parent terminal selection when a conventional method is used in the star-type connection ad hoc wireless network shown in FIGS. 8A and 8B.

FIG. 10 is a diagram showing a table containing the remaining battery times of the terminals and the parent terminal selection when the method according to the present invention is used in the star-type connection ad hoc wireless network shown in FIGS. 8A and 8B.

FIG. 11 is a diagram showing the configuration of a conventional terminal connected to a star-type connection ad hoc wireless network.

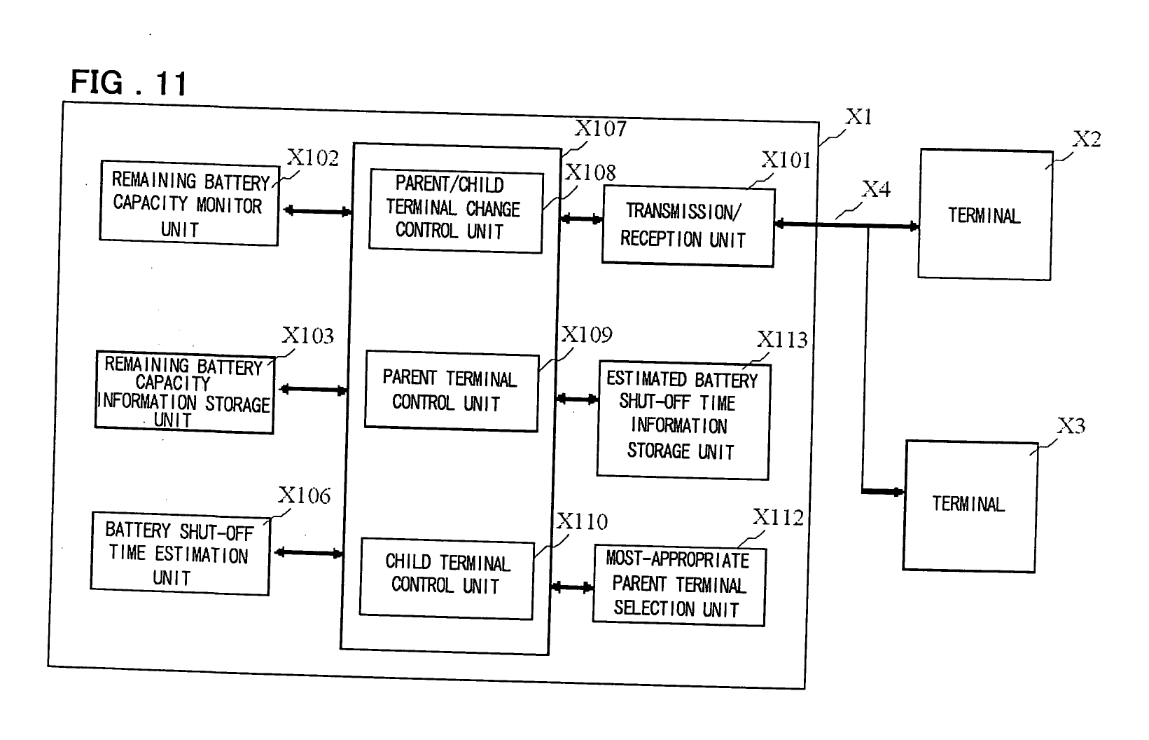

FIGS. 12A and 12B are flowcharts showing the flow of conventional parent terminal selection processing in a star-type connection ad hoc wireless network.

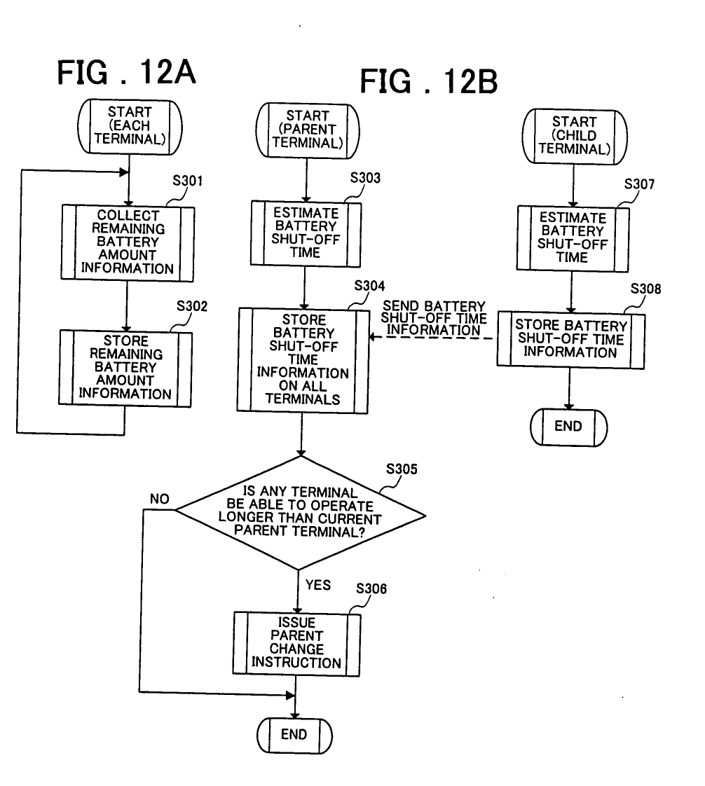

FIGS. 13A, 13B and 13C are diagrams showing the problems with the conventional technology.

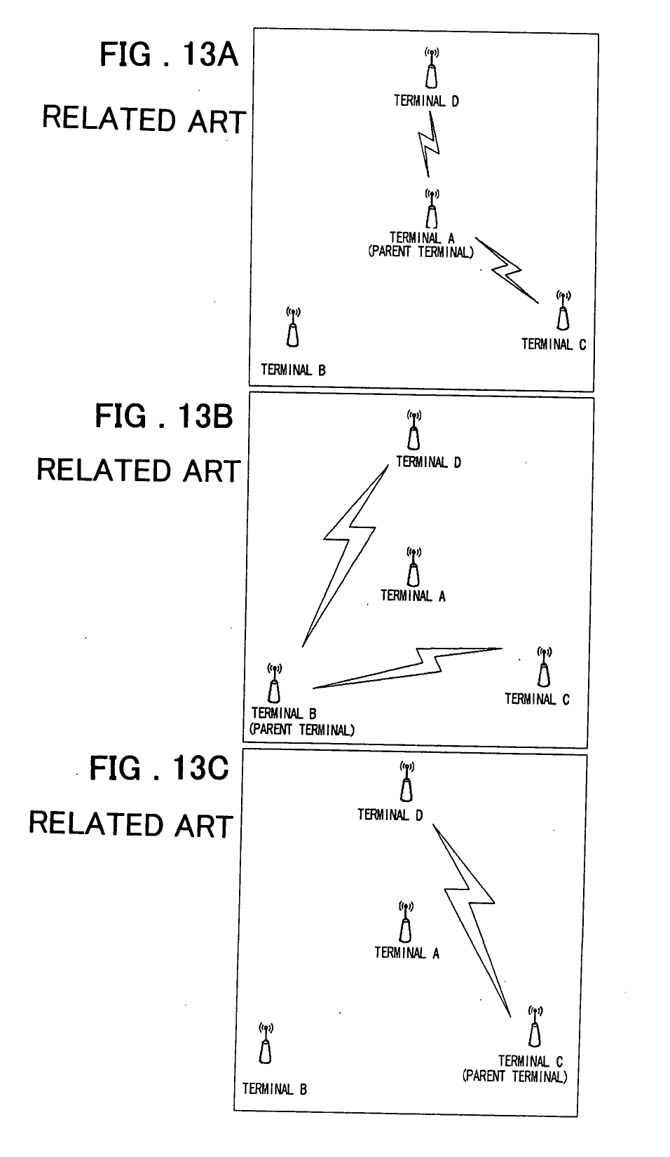

### PREFERRED MODES OF THE INVENTION

In a preferred mode, the remaining battery times of the terminals, which are estimated assuming that said each terminal becomes a parent terminal, are calculated from remaining battery capacities of the terminals received from the terminals and battery consumption amounts which are estimated assuming that said each terminal becomes a parent terminal.

It is preferred that a terminal that is a current parent terminal monitors data transmission/reception amounts among the terminals, and simulates an increase or a decrease in the data transmission/reception amounts, which are estimated assuming that said each terminal becomes a parent terminal, for calculating the estimated battery consumption amounts.

Also, it is preferred that a terminal, which maximizes a total of the remaining battery times of the terminals which are estimated assuming that said each terminal becomes a parent terminal, is selected as a parent terminal.

Further, it is preferred that a terminal, which maximizes a minimum of the remaining battery times of the terminals which are estimated assuming that said each terminal becomes a parent terminal, is selected as a parent terminal.

### First Example

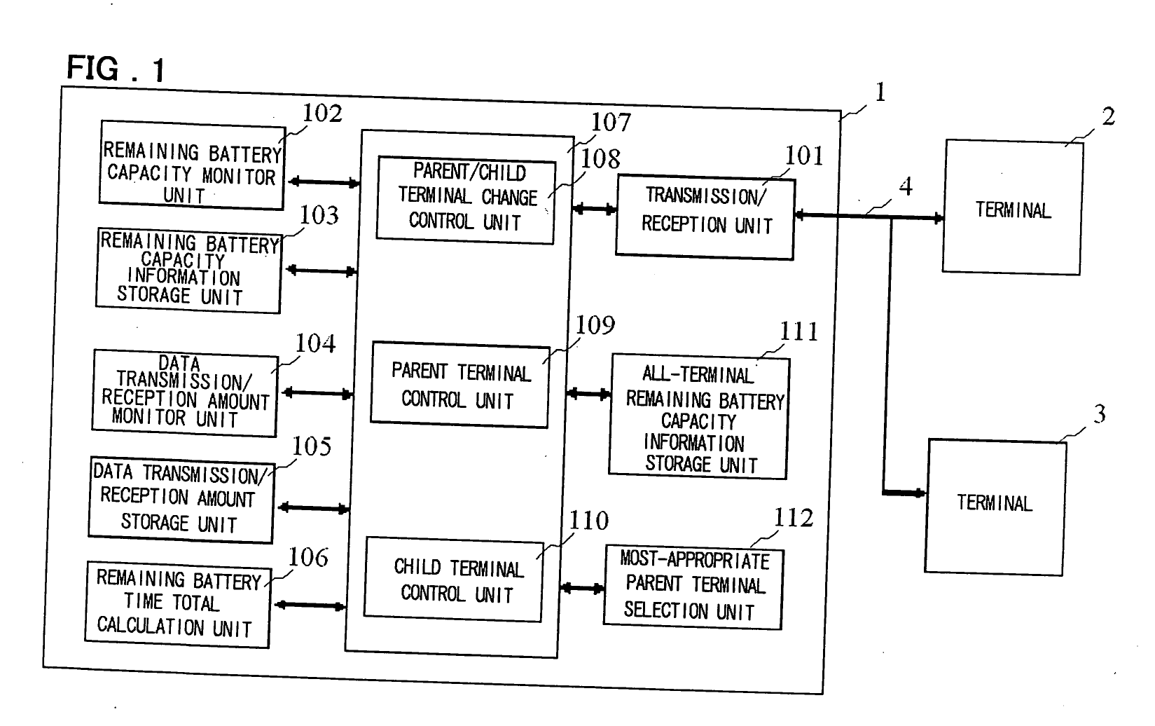

Next, examples of the present invention will be described in detail with reference to the drawings. FIG. 1 is a diagram showing the configuration of a terminal in a first example of the present invention connected to a star-type connection ad hoc wireless network. Referring to FIG. 1, a terminal 1 comprises a transmission/reception unit 101, a remaining battery capacity monitor unit 102, a remaining battery capacity information storage unit 103, a data transmission/reception amount monitor unit 104, a data transmission/reception amount storage unit 105, a remaining battery time total calculation unit 106, a control unit 107, an all-terminal remaining battery capacity information storage unit 111, and a most-appropriate parent terminal selection unit 112.

The transmission/reception unit 101 communicates with other terminals 2 and 3 via a wireless transmission line 4.

The remaining battery capacity monitor unit 102 is a block for monitoring the remaining battery capacity of this terminal. The detected remaining battery capacity is recorded in the remaining battery capacity information storage unit 103.

The data transmission/reception amount monitor unit 104 is a block for recording the amount of transmitted and received data. The detected data amount is recorded in the data transmission/reception amount storage unit 105.

The remaining battery time total calculation unit 106 is a block for calculating the total of remaining battery times of the terminals participating in the network.

The control unit 107 comprises a parent/child terminal change control unit 108 that determines whether the terminal operates as a parent terminal or a child terminal, a parent terminal control unit 109 used when the terminal operates as a parent terminal, and a child terminal control unit 110 used when the terminal operates as a child terminal. Thus, the terminal 1 can work as a parent terminal or a child terminal.

The most-appropriate parent terminal selection unit 112 calculates the total remaining battery time assuming that each of the terminals 1, 2, and 3 operates as the parent terminal, based on the remaining battery capacity information on all terminals stored in the all-terminal remaining battery capacity information storage unit 111 and the data transmission/reception amount stored in the data transmission/reception amount storage unit 105. After that, the most-appropriate parent terminal selection unit 112 selects the terminal, which maximizes the total remaining battery time, as the parent terminal.

The terminals 2 and 3, with the same configuration as that of the terminal 1 described above, operate as a parent terminal or a child terminal according to the determination result of the most-appropriate parent terminal selection unit 112 and perform communication via the wireless transmission line 4. Note that the characteristics, for example, the battery characteristics and power consumption characteristics, may be different among the terminals.

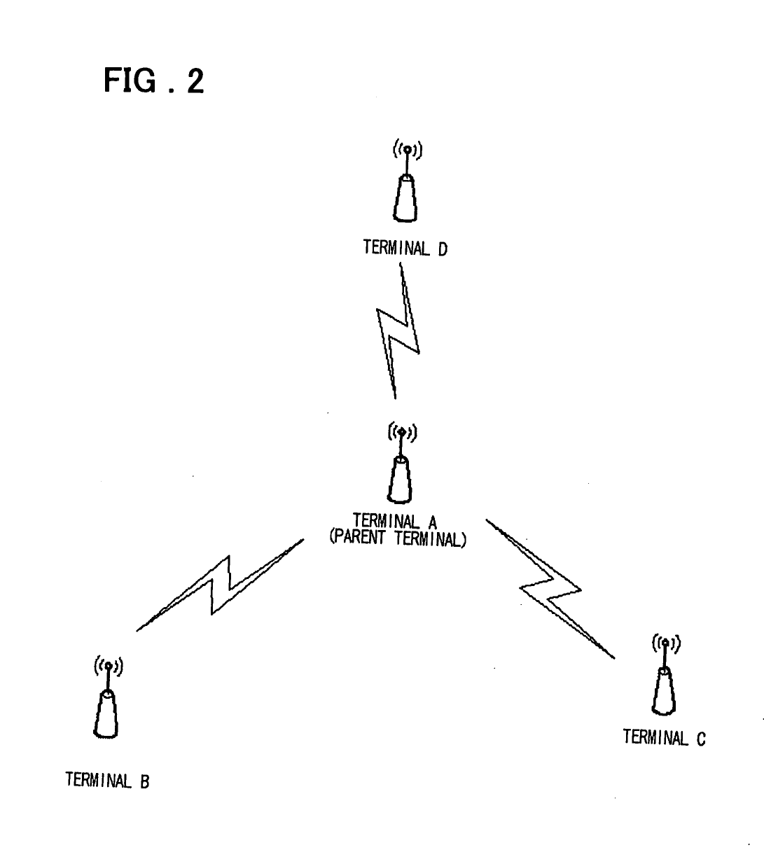

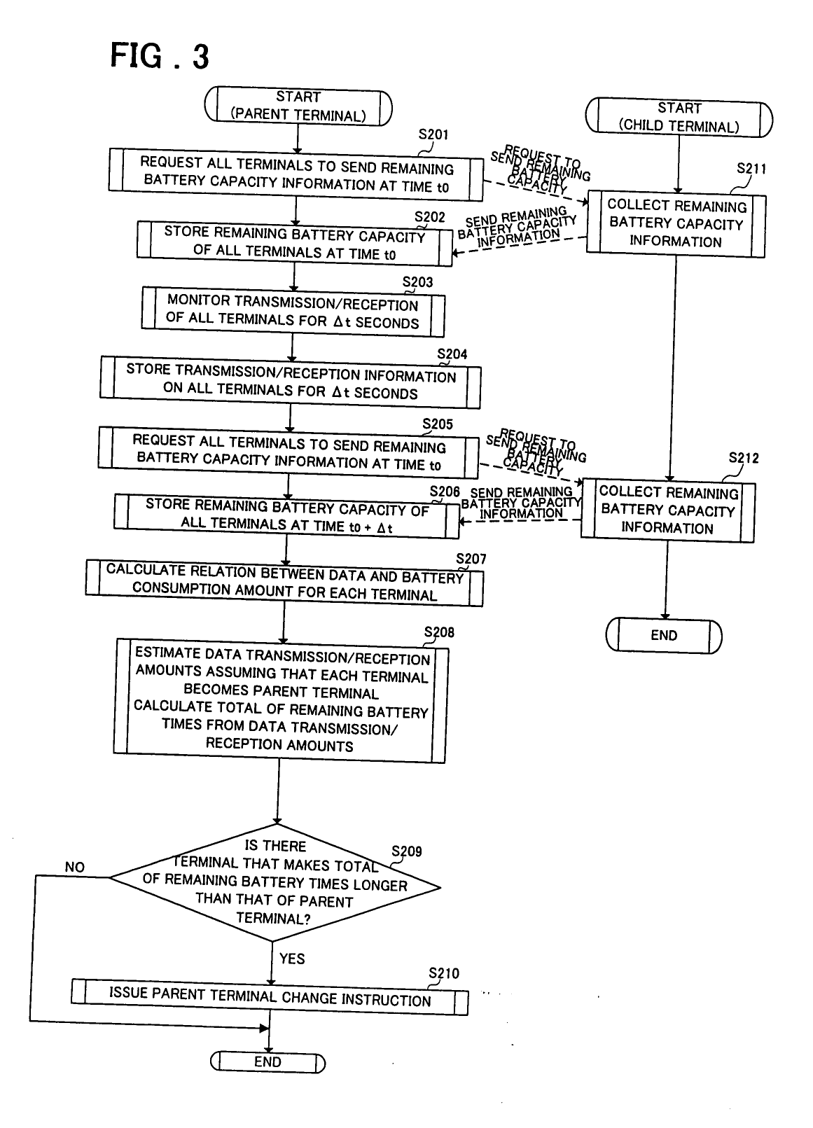

Next, the following describes the operation of the terminal in this example using a star-type network composed of four terminals as shown in FIG. 2. FIG. 3 is a flowchart showing the operation of terminals connected to the star-type network shown in FIG. 2. Referring to FIG. 3, the parent terminal (terminal A) first requests each of the child terminals (terminal B-D) to send the remaining battery capacity information (step S201).

When the request to send the remaining battery capacity information is received from the parent terminal (terminal A), the child terminal (terminals B-D) collects the remaining battery capacity information at time to via the remaining battery capacity monitor unit 102. The detected remaining battery capacity information is stored in the remaining battery capacity information storage unit 103 and, at the same time, sent to the parent terminal (terminal A) via the control unit 107 and the transmission/reception unit 101 (step S211).

The parent terminal (terminal A) stores its own remaining battery capacity information and the remaining battery capacity information received from the child terminals (terminals B-D) in the all-terminal remaining battery capacity information storage unit 111 (step S202).

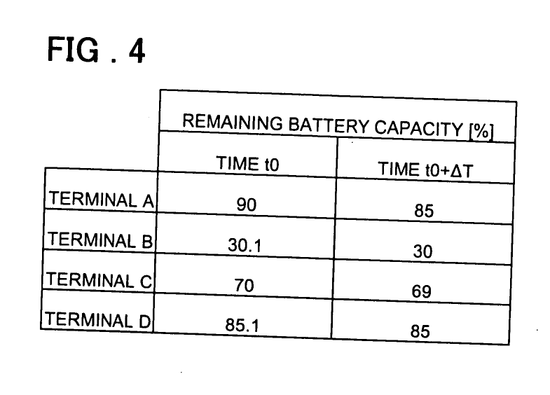

FIG. 4 is a tabular diagram showing the remaining battery capacity of all terminals stored in the all-terminal remaining battery capacity information storage unit 111. The diagram shows the remaining battery capacity in percent at time t₀ and t₀+Δt with the remaining battery capacity of a fully charged battery being 100%.

Next, the parent terminal (terminal A) monitors the communication status of the child terminals (terminal B-D) for a predetermined time (for example, Δt seconds) (step S203) and stores the data transmission/reception amount of the parent terminal and the child terminals (terminals B-D) in the data transmission/reception amount storage unit 105 (step S204).

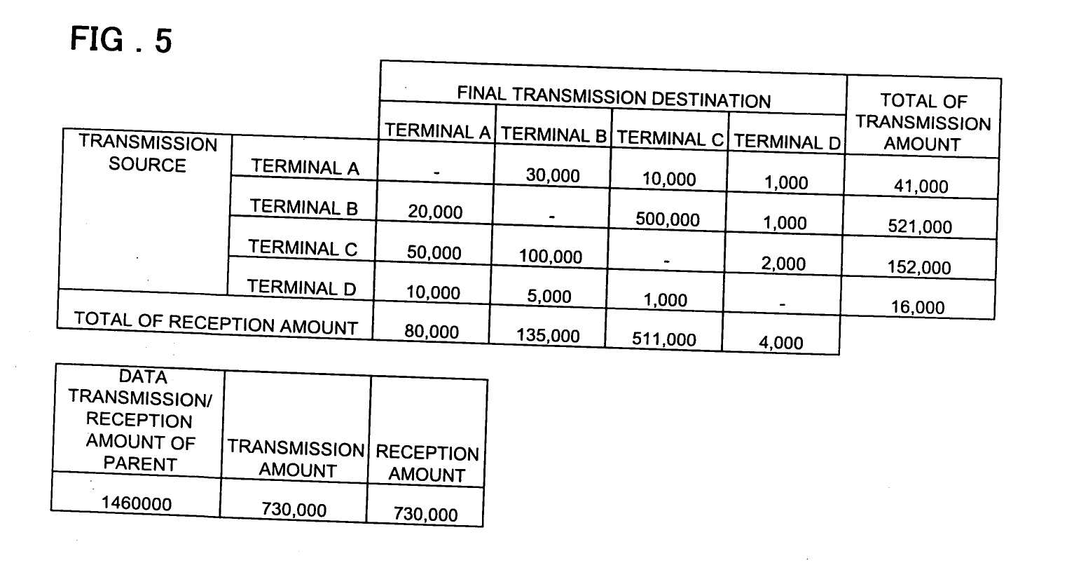

FIG. 5 is a tabular diagram showing the data transmission/reception amount among the terminals stored in the data transmission/reception amount storage unit 105. The table at the top in FIG. 5 shows the transmission/reception data amount (in bytes) among the source terminals and the final destination terminals. The total of transmission data of each terminal is shown in the rightmost column in the table at the top. Similarly, the total of reception data of each terminal is shown in the bottom line in the table at the top. The values in the table at the bottom indicate the data transmission/reception amount of the parent terminal. The transmission amount in the table at the bottom is equal to the sum of the totals of transmission data amounts in the table at the top, and the reception amount is equal to the sum of the totals of reception data amounts in the table at the top.

When the data transmission/reception amounts of all terminals are stored, the parent terminal (terminal A) requests the child terminals (terminals B-D) again to send the remaining battery capacity information at time t₀+Δt (step S205).

When the request to send the remaining battery capacity information is received from the parent terminal (terminal A), the child terminal (terminals B-D) collects the remaining battery capacity information at time t₀+Δt via the remaining battery capacity monitor unit 102. The detected remaining battery capacity information is stored in the remaining battery capacity information storage unit 103 and, at the same time, sent to the parent terminal (terminal A) via the control unit 107 and the transmission/reception unit 101 (step S212).

The parent terminal (terminal A) stores the remaining battery capacity information on the parent terminal and the child terminals (B-D) in the remaining battery capacity information storage unit 103 as shown in the example in FIG. 4 (step S206).

Next, the parent terminal (terminal A) calculates the battery amount consumed, and the data amount transmitted/received, for a predetermined time (for example, for Δt seconds) based on the remaining battery capacity information and the data transmission/reception amount information on the terminals exemplified in FIG. 4 and FIG. 5. Assuming that the battery consumption amount and the data transmission/reception amount given above are proportional, the parent terminal (terminal A) calculates the battery consumption amount per one-byte transmission/reception and stores the calculated values (step S207).

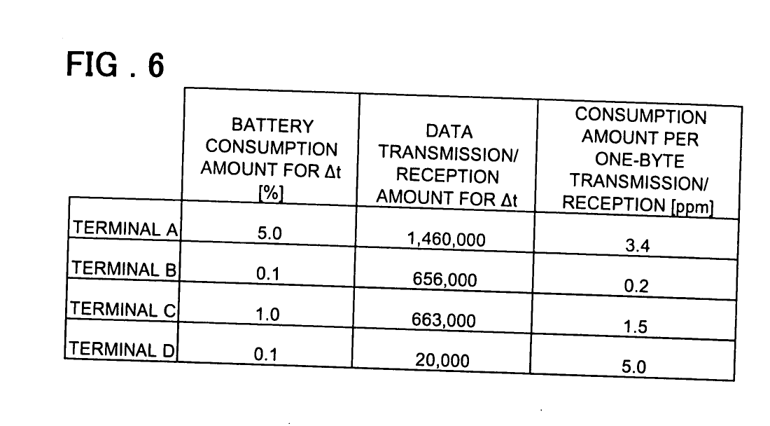

FIG. 6 shows an example in which the battery consumption amount per one-byte transmission/reception is calculated from the battery consumption amount and the data transmission/reception amount for the predetermined time (for example, for Δt seconds). For example, the parent terminal (terminal A) consumes 5% of the battery for Δt seconds and, during that period of time, transmits and receives 1,460,000 bytes of data. So, the battery consumption amount per one-byte transmission/reception is calculated as 5/1,460,000=3.4 ppm). Although the transmission power and the reception power are assumed to be equal for simplicity in the example in FIG. 6, any method may be use; for example, the transmission and the reception may be weighted differently.

Next, based on the data transmission/reception amount of each terminal stored in step S204, the remaining battery capacity stored in step S206, and the battery consumption amount calculated in step 207, the parent terminal (terminal A) estimates the remaining battery time and the total of the remaining battery times of the terminals assuming that each terminal becomes the parent terminal and (step S208).

For example, when terminal A remains the parent terminal, the remaining battery time of each terminal is calculated as follows using the data in FIG. 4, FIG. 5, and FIG. 6. The remaining battery time of terminal A is 85/5=17, the remaining battery time of terminal B is 30/0.1=300, the remaining battery time of terminal C is 69/1.0=69.0, and the remaining battery time of terminal D is 85/0.1=850.0. The total remaining battery time at this time is calculated as 1236 (that is, 17+300+69+850).

Because the parent terminal functions as a hub, the data transmission/reception amount among the child terminals is added. That is, when the terminal A described above is the parent terminal, the data transmission/reception amounts A [symbol] B, A [symbol] C, A [symbol] D, B [symbol] C, B [symbol] D, and [symbol] CD are added up. Therefore, to calculate the remaining battery time of terminal B when the parent terminal is changed to the child terminal B (C or D), the remaining battery time must be calculated based on that the data transmission/reception amounts between B [symbol] A, B [symbol] C, and B [symbol] D shifts to the data transmission/reception amounts corresponding to said terminal A.

When the parent terminal is changed to terminal B, the remaining battery time of terminal A is calculated as 85/(5.0×121,000/1,460,000)=205.1, based on the method described above and using the data in FIG. 4, FIG. 5, and FIG. 6. Note that 121,000 is the net data transmission/reception amount of terminal A calculated from the values in FIG. 5 (sum of the total of transmission amount and the total of reception amount, that is, 41,000+80,000), and 1,460,000 is the data transmission/reception amount of the parent terminal (transmission/reception amount of the whole network) shown in FIG. 5. Conversely, the remaining battery time of terminal B when the parent terminal is changed to terminal B is calculated as 30/(0.1×1,460,000/656,000)=134.8. Because terminals C and D remain child terminals when the parent terminal is changed to terminal B, the remaining battery times of those terminals are the same as those when terminal A is the parent terminal.

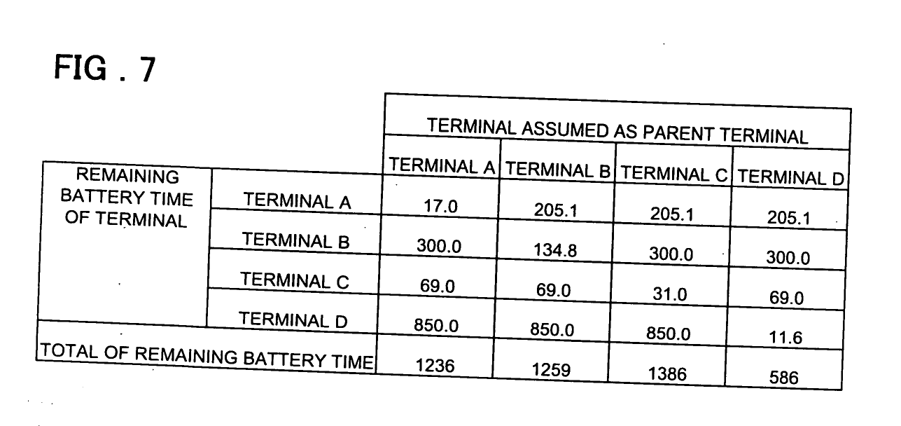

FIG. 7 is a table showing the remaining battery times of the terminals and the total values of the remaining battery times, calculated using the data in FIG. 4, FIG. 5, and FIG. 6, when each terminal is assumed to be the parent terminal.

After the remaining battery times of the terminals, which are calculated assuming that each of the terminals described above becomes the parent terminal, and the total of the remaining battery times are calculated, the parent terminal (terminal A) selects a terminal, which maximizes the remaining battery times of all terminals, as the parent terminal (step S209). If the selected terminal is not the current parent terminal, the parent terminal (terminal A) issues an instruction to the parent/child terminal change control unit 108 of all terminals to switch the parent terminal to another terminal (step S210).

For example, in the example in FIG. 7, the total of the remaining battery times of all terminals becomes the maximum when terminal C is the parent terminal. So, the parent terminal (terminal A) performs the switching operation to make terminal C the parent terminal.

The following describes the advantages of the parent terminal selection method in which a terminal, which maximizes the total of the remaining battery times of all terminals, is selected as the parent terminal. In the description, the method is compared with the conventional parent terminal selection method which is based on the battery remaining battery times.

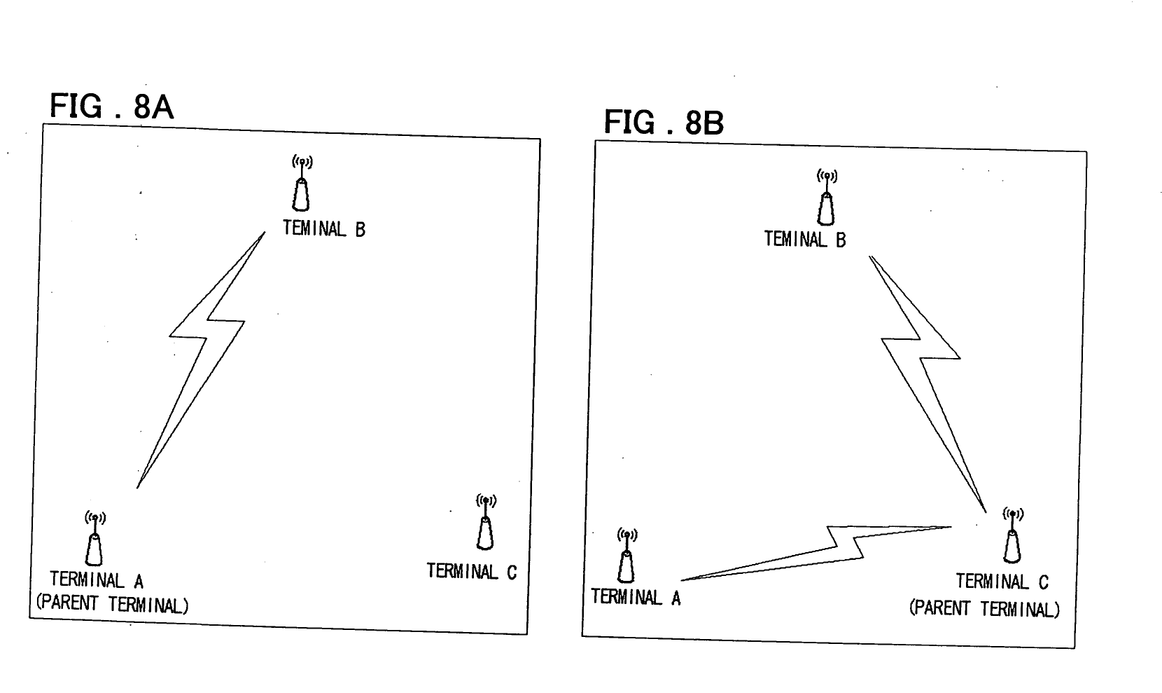

For example, consider the configuration of a network composed of three terminals such as the one shown in FIGS. 8A and 8B. In the initial state, terminal A is the parent terminal (FIG. 8A). Assume that the three terminals each have the same remaining battery capacity and consumes the same battery amount per one-byte transmission/reception and that the remaining battery capacity is 10 units and one unit of battery is consumed for each Δt seconds during communication. Also assume that communication is performed only between A [symbol] B.

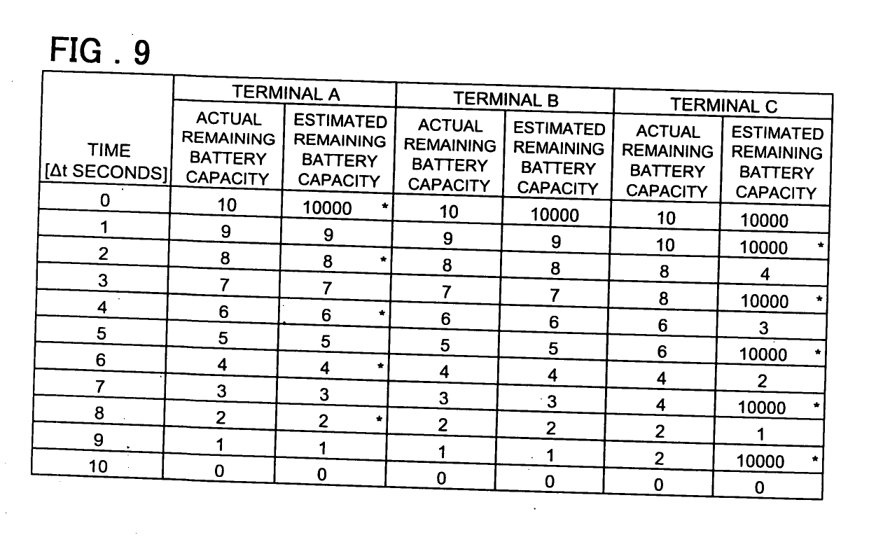

In the conventional selection method, a terminal having the longest remaining battery time is selected as the parent terminal. So, the remaining battery time of each terminal is changed as shown in FIG. 9 (Although the remaining battery time is so if no communication is performed, the upper limit value of 10000 is set). In the initial state, terminal A is the parent terminal and each of terminals A and B consumes one unit of the battery. On the other hand, there is no change in the remaining battery time of terminal C because it is not performing communication. Therefore, as indicated by * in the estimated remaining battery capacity column in FIG. 9, terminal C having the maximum remaining battery time is selected as the parent terminal in Δt seconds.

After terminal C is selected as the parent terminal, communication is performed between A [symbol] C and B [symbol] C as shown in FIG. 8B, and two units of the battery amount of terminal C are consumed in Δt seconds. On the other hand, there is no change in the data transmission/reception amount and in the battery consumption amount of terminals A and B. Because the battery consumption amount of terminal C is large, terminal A (or terminal B) is selected as the parent terminal in 2Δt seconds as indicated by * in the estimated remaining battery capacity column in FIG. 9.

After that, terminal C is selected as the parent terminal again in 3Δt seconds (because no communication is performed and the remaining battery time becomes ∞). After that, this sequence is repeated and terminal C is selected as the parent terminal at a fixed interval.

On the other hand, in the parent terminal selection method of the present invention, assume that terminal A is the parent terminal in the initial state. Consider which terminal will become the parent terminal in Δt seconds. First, the total of remaining battery times is calculated to select the parent terminal.

In Δt seconds, the total of remaining battery times is 10000+9+9=10018 when terminal A remains the parent terminal. The total of remaining battery times is 10000+9+9=10018 also when terminal B is the parent terminal. When terminal C becomes the parent terminal, the total of remaining battery times is 9+9+5=23 (The remaining battery time of terminal C is calculated as 5Δt because, according to the present invention, the communication amount is considered to be doubled when terminal C becomes the parent terminal).

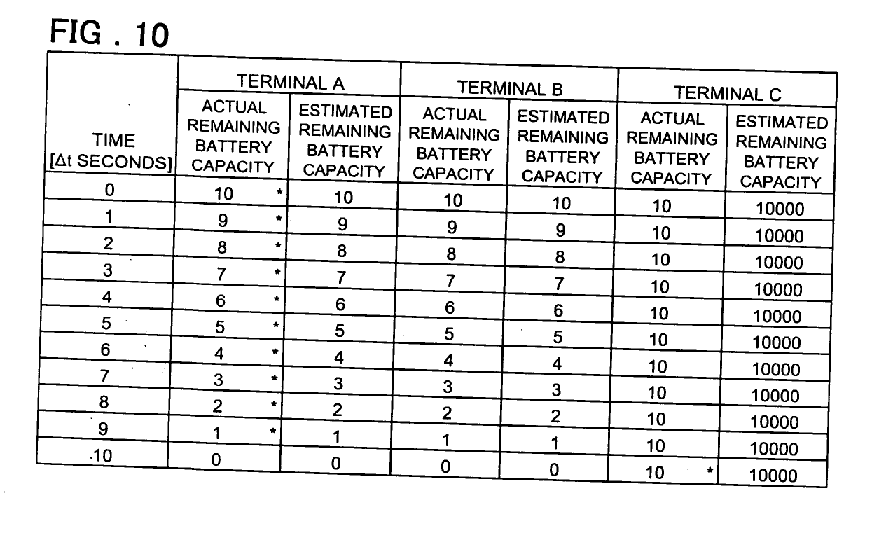

The calculation result indicates that no terminal other than terminal A maximizes the total of the remaining battery times, meaning that terminal A is selected as the parent terminal continuously. FIG. 10 shows the remaining battery capacities and the parent terminal selection.

The total of the remaining battery times of all terminals divided by the number of terminals is the average of remaining battery times. That is, the parent terminal selection criterion in this example is equivalent to the selection of the parent terminal that can increase the average of remaining battery times.

As described above, the conventional parent terminal selection method tends to select a terminal, which is not performing communication, as the parent terminal because its remaining battery time is estimated longer, sometimes resulting in wasteful communication. In contrast, the method of the present invention avoids such wasteful communication, thereby contributing to data throughput increase and power saving.

### Second Example

Next, the following describes a second example of the present invention in which the parent terminal selection criterion of the first example is modified. The second example of the present invention can be implemented by the same configuration as that of the first example only with the modification of the parent terminal selection criterion. The following describes the second example with focus on the different from the first example.

In the first example described above, the parent terminal selection criterion is that a terminal that can maximize the total of remaining battery times of all terminals is selected as the parent terminal. In contrast, in the second example, the simulation result of remaining battery times, produced on the assumption that each terminal is the parent terminal, is checked for a case (parent terminal) in which the minimum value of the remaining battery times is the maximum among all terminals. According to this parent terminal selection criterion, the case in which terminal B is the parent terminal is selected in the example shown in FIG. 7 because the minimum remaining battery time value (69.0) is the maximum among all terminals. Therefore, the parent terminal (terminal A) switches the parent terminal to terminal B.

In the method of the conventional technology, for example, in the method disclosed in Patent Document 1, a terminal having the longest remaining battery time is selected as the parent terminal. This remaining battery time is predicted simply by assuming that the battery is consumed on a linear basis. In contrast, because the estimated battery consumption amount is calculated in this example with consideration for the data transmission/reception amount of the parent terminal that functions as the hub of a wireless network, the parent terminal can be selected based on the actual wireless network life.

While the present invention has been described with reference to the examples above, it is to be understood that various modifications may be made without departing from the spirit of the present invention that the estimated remaining battery times of all network-participating terminals are calculated on the assumption that each terminal becomes the parent terminal and, based on the calculated result, the most appropriate parent terminal is selected.

For example, though examples are described in the examples above in which the parent terminal is selected according to the total of the remaining battery times of all terminals or according to the minimum value of the remaining battery times, other parent terminal selection methods are also possible. For example, with various types of statistical values calculated from the remaining battery times of the terminals, various criteria, for example, a criterion for maximizing the remaining battery times of n terminals with the smallest variations in the remaining battery times, can be used, singly or in combination, for selecting the parent terminal.

In the examples given above, the parent terminal is selected immediately after determining the remaining battery times of the terminals. Instead, it is also possible to use a method appropriately in which the calculation/determination of remaining battery times is repeated multiple times and, only when the same result is output, the parent terminal is changed to another terminal.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A parent terminal selection method for use in a star-type connection ad hoc wireless network in which a plurality of terminals, each of which can become a parent terminal, participate; wherein
said method comprising:
calculating by a terminal participating in said wireless network, remaining battery times of the terminals, which are estimated assuming that each terminal becomes a parent terminal; and
based on the calculated result, selecting a most appropriate parent terminal.

2. The parent terminal selection method as defined by claim 1, wherein
the remaining battery times of the terminals, which are estimated assuming that said each terminal becomes a parent terminal, are calculated from remaining battery capacities of the terminals received from the terminals and battery consumption amounts which are estimated assuming that said each terminal becomes a parent terminal.

3. The parent terminal selection method as defined by claim 2, wherein
a terminal that is a current parent terminal monitors data transmission/reception amounts among the terminals, and
simulates an increase or a decrease in the data transmission/reception amounts, which are estimated assuming that said each terminal becomes a parent terminal, for calculating the estimated battery consumption amounts.

4. The parent terminal selection method as defined by claim 1 wherein
a terminal, which maximizes a total of the remaining battery times of the terminals which are estimated assuming that said each terminal becomes a parent terminal, is selected as a parent terminal.

5. The parent terminal selection method as defined by claim 1 wherein
a terminal, which maximizes a minimum of the remaining battery times of the terminals which are estimated assuming that said each terminal becomes a parent terminal, is selected as a parent terminal.

6. A terminal, wherein
said terminal is adapted for participating in a star-type connection ad hoc wireless network as a parent terminal or a child terminal;
said terminal comprising:
a remaining battery time calculation unit that calculates remaining battery times of terminals which are estimated assuming that each of said terminals becomes a parent terminal; and
a most-appropriate parent terminal selection unit that selects a most-appropriate parent terminal based on the remaining battery times of the terminals which are estimated assuming that said each terminal becomes a parent terminal.

7. The terminal as defined by claim 6, wherein
said remaining battery time calculation unit calculates the remaining battery times of the terminals from remaining battery capacities of the terminals received from the terminals and estimated battery consumption amounts which are estimated assuming that said each terminal becomes a parent terminal.

8. The terminal as defined by claim 7, further comprising:
a data transmission/reception amount monitor unit that monitors data transmission/reception amounts among the terminals, wherein
when said terminal is a parent terminal, said remaining battery time calculation unit simulates an increase or a decrease in the data transmission/reception amounts, which are estimated assuming that said each terminal becomes a parent terminal, for calculating the estimated battery consumption amounts, and said most-appropriate parent terminal selection unit selects the most-appropriate parent terminal.

9. The terminal as defined by claim 6, wherein
said most-appropriate parent terminal selection unit selects a terminal, which maximizes a total of the remaining battery times of the terminals which are estimated assuming that said each terminal becomes a parent terminal, as a most appropriate parent terminal.

10. The terminal that can participate in a star-type connection ad hoc wireless network as a parent terminal or a child terminal as defined by claim 6, wherein
said most-appropriate parent terminal selection unit selects a terminal, which maximizes a minimum of the remaining battery times of the terminals which are estimated assuming that said each terminal becomes a parent terminal, as a most appropriate parent terminal.
